(19) United States
(12) Patent Application Publication
(10) Pub. No.: US 2026/0140677 A1
(43) Pub. Date: May 21, 2026

(54) INFORMATION PROCESSING APPARATUS, METHOD FOR CONTROLLING INFORMATION PROCESSING APPARATUS, AND APPLICATION

(71) Applicant: CANON KABUSHIKI KAISHA, Tokyo (JP)

(72) Inventor: HIROAKI MORIMOTO, Kanagawa (JP)

(21) Appl. No.: 19/416,573

(22) Filed: Dec. 11, 2025

Related U.S. Application Data
(63) Continuation of application No. PCT/JP2024/021590, filed on Jun. 14, 2024.

(30) Foreign Application Priority Data
Jun. 21, 2023 (JP) 2023-101671

(51) Int. Cl. G06F 3/12

(52) U.S. Cl. CPC G06F 3/1229; G06F 3/121

(57) ABSTRACT

An application stored in an information processing apparatus causes the information processing apparatus to acquire a notification received from a printing apparatus by a generic print function provided by the information processing apparatus and cause a generic notification function provided by the information processing apparatus to display information that is set based on content of the acquired notification.

### CROSS-REFERENCE TO RELATED APPLICATIONS

This application is a Continuation of International Patent Application No. PCT/JP2024/021590, filed Jun. 14, 2024, which claims the benefit of Japanese Patent Application No. 2023-101671, filed Jun. 21, 2023, both of which are hereby incorporated by reference herein in their entirety.

### BACKGROUND

### Field of the Technology

The present disclosure relates to an information processing apparatus, a method for controlling the information processing apparatus, and an application.

### Description of the Related Art

Standard class drivers (hereinafter, also referred to as “standard drivers”) that can be used for printing apparatuses provided by a plurality of vendors in common have been provided in recent years. Such standard drivers are bundled with operating system (OS) packages. Standard drivers are configured to enable specification of print functions in conformity with print capability information generated based on information acquired from connected printing apparatuses. Users who use standard drivers can thus specify print functions in conformity with the capabilities of the connected printing apparatuses. Standard drivers can be associated with applications intended for function extension (hereinafter, also referred to as “extension applications”). Extension applications are provided by vendors that provide printing apparatuses. By providing the extension applications, the vendors can provide functions (extended functions) that are unable to be implemented with standard drivers alone. For example, Japanese Patent Laid-Open No. 2020-160989 describes a technique for providing user notifications based on the user's print settings using an extension application.

Status applications are commonly known that, when events (such as a no-ink warning and a paper-out error) occur in a printing apparatus during printing, notify users of detailed descriptions and levels of significance of the events that have occurred. Meanwhile, there are no known mechanism that appropriately notify users of detailed descriptions and levels of significance of events that have occurred when printing is performed using a standard driver. It has therefore been difficult for printing apparatus vendors to customize the content of notification depending on events occurring during printing if printing is performed using a standard driver.

### SUMMARY

According to an aspect of the present disclosure, an application, which is stored in an information processing apparatus, causes the information processing apparatus to acquire a notification received from a printing apparatus by a generic print function provided by the information processing apparatus and cause a generic notification function provided by the information processing apparatus to display information that is set based on content of the acquired notification.

Features of the present disclosure will become apparent from the following description of embodiments with reference to the attached drawings.

### BRIEF DESCRIPTION OF THE DRAWINGS

FIG. 1 is a block diagram illustrating an example of a hardware configuration of a printing system according to a first embodiment.

FIG. 2A is a diagram schematically illustrating an example of a configuration of the printing system according to the first embodiment.

FIG. 2B is a diagram schematically illustrating an example of a configuration of the printing system according to the first embodiment.

FIG. 3 is a sequence diagram illustrating an example of print processing according to the first embodiment.

FIG. 4 is a flowchart illustrating an example of display item determination processing of a notification unit according to the first embodiment.

FIG. 5A is a diagram illustrating an example of notification definition information according to the first embodiment.

FIG. 5B is a diagram illustrating an example of notification definition information according to the first embodiment.

FIG. 6A is a diagram illustrating an example of a notification screen that a host computer displays according to the first embodiment.

FIG. 6B is a diagram illustrating an example of a notification screen that the host computer displays according to the first embodiment.

FIG. 7 is a flowchart illustrating an example of display item determination processing of a notification unit according to a second embodiment.

FIG. 8 is a flowchart illustrating an example of display item determination processing of a notification unit according to a third embodiment.

FIG. 9 is a diagram illustrating an example of notification definition information according to the third embodiment.

FIG. 10 is a diagram illustrating an example of a notification screen according to the third embodiment.

FIG. 11 is a flowchart illustrating an example of display item determination processing of a notification unit according to a fourth embodiment.

FIG. 12 is a diagram illustrating an example of notification definition information according to the fourth embodiment.

FIG. 13 is a diagram illustrating an example of a notification screen according to the fourth embodiment.

FIG. 14 is a flowchart illustrating an example of display item determination processing of a notification unit according to a fifth embodiment.

FIG. 15A is a diagram illustrating an example of notification definition information according to the fifth embodiment.

FIG. 15B is a diagram illustrating an example of notification definition information according to the fifth embodiment.

FIG. 16A is a diagram illustrating an example of a notification screen according to the fifth embodiment.

FIG. 16B is a diagram illustrating an example of a notification screen according to the fifth embodiment.

FIG. 17 is a diagram illustrating an example of information to be set in the notification definition information according to the first embodiment.

FIG. 18 is a diagram illustrating an example of information to be set in the notification definition information according to the third embodiment.

FIG. 19 is a diagram illustrating an example of information to be set in the notification definition information according to the fourth embodiment.

FIG. 20 is a diagram illustrating an example of information to be set in the notification definition information according to the fifth embodiment.

### DESCRIPTION OF THE EMBODIMENTS

Embodiments of the present disclosure will be described in detail below with reference to the attached drawings. Note that the following embodiments are not intended to limit the present disclosure, and all combinations of features described in the embodiments are not necessarily essential to the solving solution of the present disclosure.

### First Embodiment

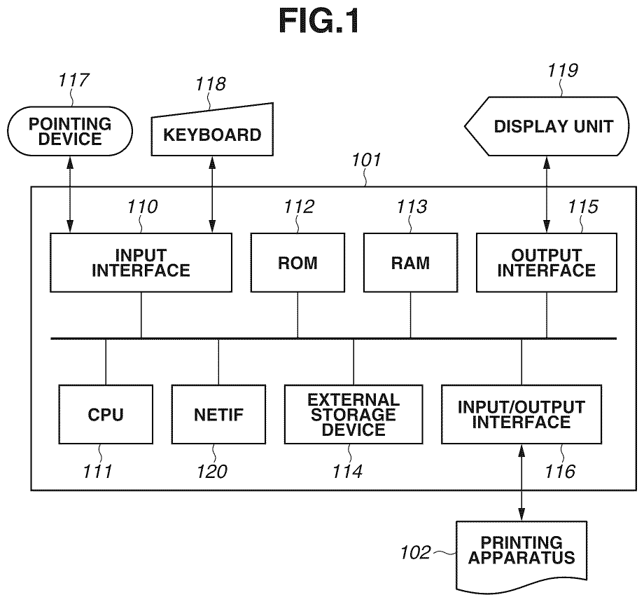

FIG. 1 is a block diagram illustrating a hardware configuration of a printing system according to the present embodiment. The printing system includes a host computer 101. FIG. 1 mainly illustrates the block configuration of the host computer 101. The host computer 101 is an example of an information processing apparatus. The host computer 101 includes an input interface 110, a central processing unit (CPU) 111, a read-only memory (ROM) 112, a random-access memory (RAM) 113, an external storage device 114, an output interface 115, an input/output interface 116, and a network interface (NETIF) 120. Input devices such as a keyboard 118 and a pointing device 117 are connected to the input interface 110. A display device such as a display unit 119 is connected to the output interface 115. The NETIF 120 controls data transfer with external devices via a network. In the example of FIG. 1, the display unit 119, the pointing device 117, and the keyboard 118 are illustrated as examples of devices separate from the host computer 101. However, these devices may be included in the host computer 101. The display unit 119 may be a touchscreen display having the functions of an input/output device.

The ROM 112 stores an initialization program. The external storage device 114 stores a group of application programs, an operating system (OS), print data generation software, and other various types of data. The RAM 113 is used as a work memory and the like in executing various programs stored in the external storage device 114, whereby various programs can be run on the host computer 101.

In the present embodiment, functions and processing of the host computer 101 to be described below are implemented by the CPU 111 performing processing based on the procedures of programs stored in the ROM 112.

A printing apparatus 102 that is an output device is connected to the host computer 101 via the input/output interface 116. The printing apparatus 102 will be described by using an inkjet printing apparatus that prints by discharging ink onto a sheet surface as an example. However, printing may be performed by other methods (for example, electrophotography). While the printing apparatus 102 is described by using a physically existing apparatus as an example, the printing apparatus 102 may be a virtual printing apparatus that exists in the cloud. For example, when a print support system receives events from the printing apparatus 102, the print support system issues notifications using a popup notification function. By contrast, the print support system may be configured to not issue notifications using the popup notification function when events are received from a server system. The host computer 101 may be a desktop personal computer, a smartphone, a tablet terminal, or a laptop personal computer. The input/output interface 116 may be either wired or wireless. The host computer 101 and the printing apparatus 102 may be connected via a local area network (LAN) or a wide area network (WAN) such as the Internet.

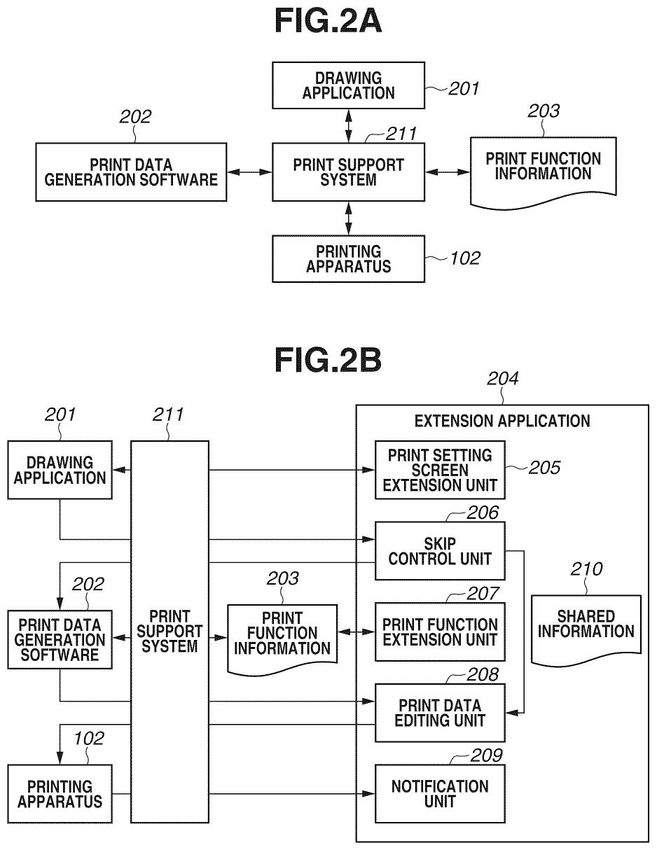

FIGS. 2A and 2B are diagrams schematically illustrating configurations of the printing system. FIG. 2A is a diagram illustrating a typical configuration where an extension application 204 is not associated with print data generation software 202 or the printing apparatus 102. In other words, FIG. 2A is a diagram illustrating the configuration of the printing system where the extension application 204 is not used.

FIG. 2B is a diagram illustrating a configuration of the printing system according to the present embodiment where the extension application 204 is associated with the print data generation software 202 and the printing apparatus 102.

An example of the printing system with the typical configuration will initially be described with reference to FIG. 2A. The printing system with the typical configuration includes a drawing application 201 and print data generation software 202. Moreover, print function information 203 is stored in the RAM 113 or the external storage device 114. The drawing application 201 and the print data generation software 202 are programs that can run on the host computer 101. The drawing application 201 is software for generating contents (drawing data) to be printed. Examples of the drawing application 201 include various types of applications for users to operate, including word processing applications and spreadsheet applications.

The print support system 211 is a component provided by the OS, and mediates various instructions and information exchanges between the drawing application 201, the print data generation software 202, the printing apparatus 102, and the extension application 204. The print support system 211 is a generic print-related function provided by the OS of the host computer 101.

The print data generation software 202 can refer to the print function information 203 via the print support system 211. The print data generation software 202 is software provided by the vendor (manufacturer) that provides the OS included in the host computer 101. The print data generation software 202 is software that can generate image data and print setting information to be transmitted to the printing apparatus 102 in compliance with the Internet Printing Protocol.

The drawing application 201 can display a print setting screen provided by one of the print data generation software 202, the OS, and the drawing application 201 to configure print setting information.

The print setting screen includes setting items (hereinafter, also referred to as “control items”) representing configurable print functions, and control items indicating the setting values thereof. The print setting screen displays control items based on capability information (information configurable as print settings) provided by the print data generation software 202.

The print data generation software 202 determines the capability information based on the print function information 203. The print function information 203 is data indicating all configurable print functions, their setting values, and print functions of which exclusive relationships between setting values are specified.

The print function information 203 is dynamically generated by the print data generation software 202. Specifically, the print data generation software 202 or the OS can be configured to acquire attribute data about the printing apparatus 102 from the printing apparatus 102, and generate the print function information 203 based on attribute information in the acquired attribute data. Where the print function information 203 is dynamically generated, the generated print function information 203 is editable. The attribute data on the printing apparatus 102 acquired from the printing apparatus 102 refers to response data obtained by issuing an Internet Printing Protocol (IPP) Get-Printer-Attributes operation to the printing apparatus 102. The response includes attribute information indicating functions that can be specified by the printing apparatus 102 (capabilities of the printing apparatus 102), and setting values related to the attribute information. The response data is stored in the RAM 113.

With such a configuration, the print data generation software 202 can configure print functions usable by each printing apparatus 102 in a user-specifiable manner depending on the connected printing apparatus 102. In other words, even when printing apparatuses with different functions or printing apparatuses developed by different vendors are connected, the print data generation software 202 can configure usable print functions in a user-specifiable manner depending on the connected printing apparatuses.

A configuration where an IPP standard driver is used as the print data generation software 202 will be described. The IPP standard driver is a printing apparatus driver that performs print processing in compliance with the specifications of the standard printing protocol called IPP. The IPP standard driver is not a printing apparatus driver specific to the model of the printing apparatus 102 but a standard class driver that can be used for a plurality of printing apparatuses in common. The IPP standard driver acquires attribute information from the connected printing apparatus 102 and generates the print function information 203 based on the attribute information so that users can specify print functions supported by the connected printing apparatus 102. In such a manner, the IPP standard driver that is the print data generation software 202 can dynamically generate the print function information 203.

Receiving a print request from the user, the drawing application 201 issues print instructions to the print support system 211. The print instructions include print setting information for instructing operation of the print data generation software 202 and the printing apparatus 102.

The print setting information specified via the print setting screen displayed based on the capability information based on such print function information 203 is included in the print instructions output from the drawing application 201. The print instructions output from the drawing application 201 include data to be drawn, aside from the print setting information. The OS generates intermediate data (also referred to as input data) based on the print instructions output from the drawing application 201, and passes the intermediate data to the print data generation software 202. Examples of data that the drawing application 201 outputs for printing purposes include data of Graphics Device Interface (GDI) format and data of Extensible Markup Language (XML) Paper Specification (XPS) format.

Suppose that the IPP standard driver is used as the print data generation software 202. If the drawing application 201 outputs data of GDI format, the OS performs data format conversion. More specifically, the OS converts the data of GDI format output from the drawing application 201 into data of XPS format. The OS then passes the converted data of XPS format to the print data generation software 202 as intermediate data. On the other hand, if the drawing application 201 outputs data of XPS format, the OS passes the data of XPS format to the print data generation software 202 as intermediate data. The intermediate data includes the drawing data that is information about images to be formed on sheets and the print setting information set by the user.

The print data generation software 202 converts the acquired intermediate data into print data interpretable by the printing apparatus 102, and transmits the print data to the printing apparatus 102. The print data includes the drawing data that is the information about images to be formed on sheets, and print setting attribute information (attribute information for specifying print settings) generated based on the print setting information set by the user. The print setting attribute information includes the attribute information indicating the functions that can be specified by the printing apparatus 102 (capabilities of the printing apparatus 102), and the setting values related to the attribute information.

The printing apparatus 102 performs printing on sheets based on the print data transmitted from the print data generation software 202. Here, the printing apparatus 102 forms the drawing data included in the print data on sheets through operation based on the print setting attribute information included in the print data. The print setting attribute information includes attribute information for specifying print quality (such as image quality priority and speed priority), two-sided printing, and the like, and their setting values. For example, if the print setting attribute information includes the attribute information for specifying two-sided printing, the printing apparatus 102 performs two-sided printing.

FIG. 2B is a diagram illustrating the configuration of the present embodiment when the extension application 204 is associated with the print data generation software 202 and the printing apparatus 102. Note that components and processing not mentioned in particular below are similar to those of FIG. 2A.

The extension application 204 is software for extending the functions of the print data generation software 202 and not included in (bundled with) the OS in advance. The user therefore operates the host computer 101 to download the extension application 204 from a server via the Internet and install the extension application 204 on the host computer 101. Alternatively, the extension application 204 may be automatically installed on the host computer 101 based on connection of the printing apparatus 102 to the host computer 101. Specifically, when the printing apparatus 102 is connected to the host computer 101, the OS acquires device identification information from the printing apparatus 102. The OS may download the extension application 204 corresponding to the acquired device identification information from the server via the Internet, and install the extension application 204 on the host computer 101. In such a manner, the print data generation software 202 and the extension application 204 are stored in the host computer 101 as separate files.

The print data generation software 202 and the extension application 204 may be updated for upgrade. The update processes are also performed at respective different timings. In other words, the timing when the host computer 101 acquires the print data generation software 202 and the timing when the host computer 101 acquires the extension application 204 are different.

The trigger for the host computer 101 to acquire the print data generation software 202 and the trigger for the host computer 101 to acquire the extension application 204 are also different. When the extension application 204 is installed, the OS associates the extension application 204 with the print data generation software 202 and the corresponding printing apparatus 102.

The extension application 204 described in the present embodiment includes a print setting screen extension unit 205, a skip control unit 206, a print function extension unit 207, a print data editing unit 208, and a notification unit 209. The extension application 204 also includes shared information 210 that can be accessed by these units in common. The actual entity of the shared information 210 is a file stored in the external storage device 114 or information stored in the RAM 113.

The extension application 204 writes and reads information to/from the shared information 210 using application program interfaces (APIs) provided by the OS. The extension application 204 may terminate its operation each time the processing of each unit ends. In such a case, the OS launches the extension application 204 each time a request to use one of the units is received. Other configurations are also conceivable. For example, the OS may terminate the operation of the extension application 204 when the processing of the print setting screen extension unit 205 ends, but keep the extension application 204 running when the processing of the skip control unit 206 ends. Moreover, the extension application 204 may cancel the processing of each unit partway. If the extension application 204 cancels processing, the OS deletes the job being processed in the print queue.

Receiving a print request from the user, the drawing application 201 issues print instructions to the print support system 211. Like the configuration of FIG. 2A, the print instructions include print setting information. Even in the configuration of FIG. 2B, like the configuration of FIG. 2A, the drawing application 201 can display the print setting screen for specifying print setting information. In the configuration of FIG. 2B, a print setting screen provided by the extension application 204 can also be displayed. Specifically, a print setting screen provided by the print setting screen extension unit 205 included in the extension application 204 is displayed. In other words, the print setting screen extension unit 205 performs print setting screen display control. Whether to display the print setting screen provided by the print setting screen extension unit 205 depends on user operation. For example, the print setting screen provided by the extension application 204 is displayed based on selection of a predetermined object on the print setting screen provided by the drawing application 201.

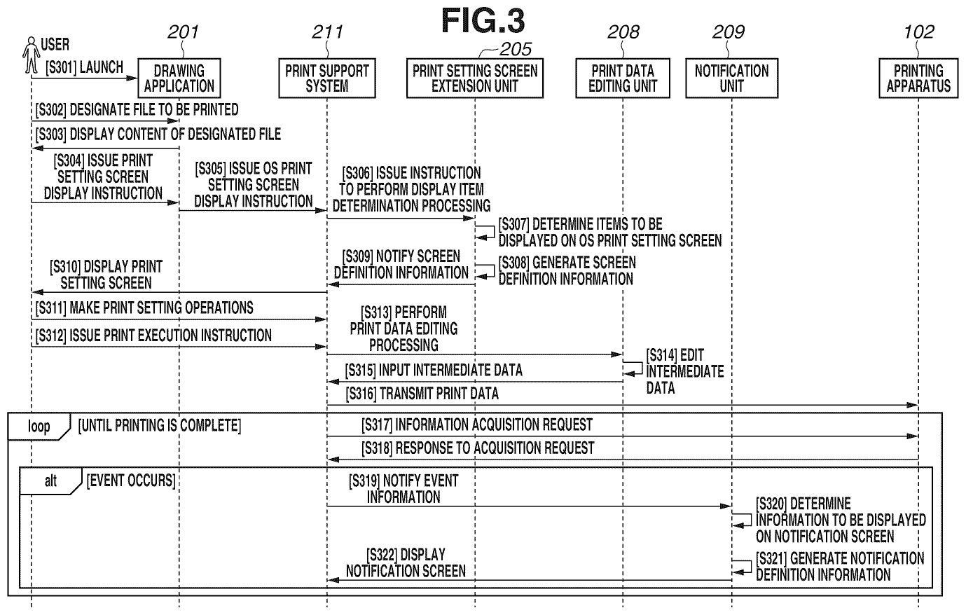

The print setting screen extension unit 205 can also extend display items of the print setting screen provided by the OS based on information acquired from the printing apparatus 102 and information about the drawing application 201. This function will be described below with reference to FIG. 3. When the drawing application 201 accepts a print request from the user and issues print instructions to the print support system 211, the print support system 211 launches the skip control unit 206.

The skip control unit 206 performs processing (skip control processing) for controlling whether to perform skip processing that skips processing of the print data generation software 202. The skip control unit 206 is unable to acquire the intermediate data or the print setting information. The processing of the print data generation software 202 refers to processing for converting the intermediate data of XPS format into a Portable Document Format (PDF) or Printer Working Group (PWG) Raster format.

After the skip control processing of the skip control unit 206, the print support system 211 generates intermediate data based on the print instructions output from the drawing application 201, and passes the intermediate data to the print data generation software 202.

If the skip control unit 206 does not perform the skip processing, the print data generation software 202 processes the intermediate data into print data interpretable by the printing apparatus 102, and passes the print data to the print data editing unit 208. Examples of the print data interpretable by the printing apparatus 102 include data of PDF format and PWG Raster format. The print data generation software 202 also converts setting values interpretable by the print data generation software 202 in the print setting information into print setting attribute information.

On the other hand, if the print data generation software 202 performs the skip processing, the intermediate data is not processed by the print data generation software 202 but passed to the print data editing unit 208. This enables the print data editing unit 208 to process the intermediate data. Note that even when the skip processing is performed, the print data generation software 202 converts the setting values interpretable by the print data generation software 202 in the print setting information into print setting attribute information.

Examples of the case where the processing of the print data generation software 202 can be skipped include when enlargement/reduction processing is to be performed by the print data editing unit 208. The intermediate data can retain data in vector format. Vector format data degrades less during enlargement/reduction compared to raster format data. In configurations where the print data generation software 202 outputs image of raster format, the processing of the print data generation software 202 can typically be skipped so that the intermediate data is processed by the print data editing unit 208. The print data editing unit 208 edits the intermediate data passed from the print data generation software 202 via the print support system 211 or the print data processed by the print data generation software 202. Take layout printing as an example of the editing content. The print data editing unit 208 changes the layout of the intermediate data or the print data based on print setting information about the layout printing received from the OS. The layout printing refers to laying out N pages of data on one page and printing the layout data, for example, and is called N-in-1, N-up, or the like (N represents the number of pages.)

The print data editing unit 208 can display a user interface (UI) screen on the display unit 119, and can display the layout result of the intermedia data or print data as a preview screen. After the editing of the print data by the print data editing unit 208, the print data is passed to the printing apparatus 102 via the print support system 211.

The printing apparatus 102 performs printing on sheets based on the accepted print data. If the print data generation software 202 is skipped by the skip control unit 206, the print data editing unit 208 may convert the received intermedia data into print data interpretable by the printing apparatus 102.

The extension application 204 includes the print function extension unit 207. The print function extension unit 207 can edit the print function information 203 generated by the print data generation software 202 or the OS.

The extension application 204 thus has the function of editing the print function information 203. The print function extension unit 207 can add functions provided by the extension application 204. Moreover, the print function extension unit 207 can add functions that are supported by the printing apparatus 102 and not by the print data generation software 202, add exclusive relationships between the setting values of print functions, etc. Examples of the functions that are supported by the printing apparatus 102 and not by the print data generation software 202 include a stapleless binding function of binding sheets by crimping without using staples.

The OS launches the print function extension unit 207 when the extension application 204 is first associated with the printing apparatus 102 and the print data generation software 202. The OS may also launch the print function extension unit 207 at any other timing, such as upon startup of the OS. This enables the print function extension unit 207 to detect extended functions and add the extended functions to the print function information 203 when optional devices (such as a finisher) are added to the printing apparatus 102 afterward and the print-related functions are extended.

The extension application 204 includes the notification unit 209. The notification unit 209 can display notifications to the user in response to the occurrence of errors in the printing apparatus 102. For example, when a no-sheet error occurs in the printing apparatus 102, the print support system 211 detects the error. The print support system 211 then displays messages on the display unit 119 using the popup notification function that is an OS function. When the user presses this popup notification, the notification unit 209 of the extension application 204 is called by the OS, and the UI screen of the notification unit 209 is displayed. The popup notification function is a notification function for general uses. In the present embodiment, the extension application 204 uses the popup notification function via the print support system 211. The popup function is a function that can be used by any application running on the host computer 101, not necessarily print-related applications.

The UI screen of the notification unit 209 can display, for example, detailed messages about the no-sheet error, a sheet loading method, and the like. Pressing shall include mouse click operations, as well as touch and tap operations on the touchscreen display.

The configuration of the extension application 204 for implementing the present embodiment is not limited to that including all the foregoing functions (units). Only some of the functions may be included. Other functions may also be included. The extension application 204 may be referred to simply as printing software.

As described above, the extension application 204 includes at least one of the following functions. The functions include the function of displaying a print setting screen (print setting screen extension unit 205) and the function of controlling whether to skip the processing of the print data generation software 202 (skip control unit 206). The functions also include the function of editing the print data to be input to the printing apparatus 102 (print data editing unit 208) and the function of extending functions that can be specified by the print data generation software 202 (print function extension unit 207). The functions also include the function of displaying a screen in response to the occurrence of errors in the printing apparatus 102 (notification unit 209).

FIG. 3 is a sequence diagram illustrating a procedure for notification screen display item determination processing of the notification unit 209 according to the present embodiment. Suppose here that the drawing application 201 does not have the function of providing a print setting screen, and the print setting screen provided by the print support system 211 is displayed.

In step S301, the drawing application 201 initially receives instructions from the user, and starts processing. In step S302, the drawing application 201 accepts designation of a file to be printed from the user. In step S303, the drawing application 201 displays the content of the designated file to the user by drawing the designated file on the application screen. In step S304, to print the file displayed in step S303, the drawing application 201 accepts a print setting screen display instruction from the user. In step S305, the drawing application 201 issues an OS print setting screen display instruction to the print support system 211 provided by the OS. The print support system 211 has the role of adding display items to the OS print setting screen based on screen definition information notified from the print setting screen extension unit 205. In step S306, the print support system 211 issues an instruction to perform display item determination processing to the print setting screen extension unit 205. The display item determination processing refers to processing where the print setting screen extension unit 205 determines items to be displayed on the OS print setting screen. In step S307, the print setting screen extension unit 205, accepting the instruction issued in step S306, determines the items to be displayed on the OS print setting screen. In step S308, the print setting screen extension unit 205 generates screen definition information based on the display items determined in step S307. In step S309, the print setting screen extension unit 205 notifies the print support system 211 of the generated screen definition information. In step S310, the print support system 211 notified of the screen definition information in step S309 adds the display items to the OS print setting screen based on the notified screen definition information, and displays the print setting screen to the user.

In step S311, to obtain desired print results, the user makes print setting operations on the print setting screen displayed by the print support system 211. The user may display the print setting screen provided by the print setting screen extension unit 205 of the extension application 204 from the print setting screen displayed by the support system 211, and configure print settings.

Examples of the operations include changing the sheet size and sheet type. Once step S311 is complete, then in step S312, the user issues a print execution instruction to the print support system 211.

Accepting the print execution instruction, the print support system 211 instructs the print data generation software 202 to generate print data based on the print instructions accepted from the drawing application 201. The following description assumes that the skip control is enabled here, and the data output from the drawing application 201 is intermediate data of XPS format and input to the print data editing unit 208.

In step S313, the print data editing unit 208 performs print data editing processing on the print data generated by the print data generation software 202.

In step S314, the print data editing unit 208 edits the intermediate data based on the print settings specified by the user in step S311. In step S315, the print data editing unit 208 inputs the edited intermediate data to the print support system 211. The print data editing unit 208 inputs the intermediate data to the print support system 211, specifying which format to convert the intermediate data into. The print support system 211 converts the intermediate data into the format specified by the print data editing unit 208 to generate print data, and registers the print data in the print queue.

In step S316, the print support system 211 transmits the input print data to the printing apparatus 102. In step S317, with the transmission of the print data started, the print support system 211 transmits an acquisition request for information about the printing apparatus 102. In step S318, the print support system 211 receives response to the acquisition request. The transmission of the acquisition request for information about the printing apparatus 102 and the response are repeated until the printing apparatus 102 completes the print processing.

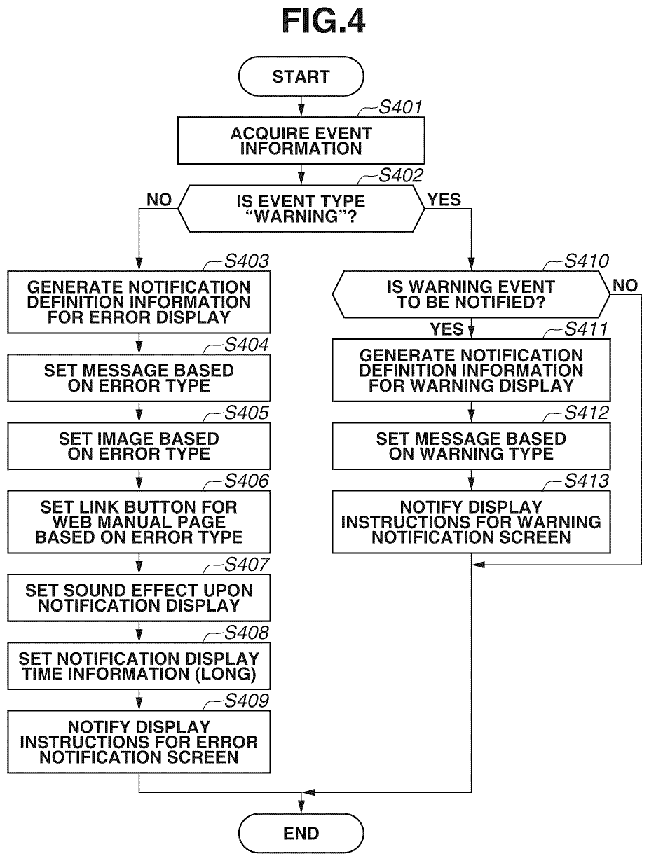

The information about the printing apparatus 102 acquired by the print support system 211 here includes event information indicating the content of events occurring during the print processing, such as an error and warning. If the print support system 211 detects the occurrence of an event such as an error and warning in the printing apparatus 102 before the completion of printing is detected, then in step S319, the print support system 211 notifies the notification unit 209 of event information about the event that has occurred. In step S320, the notification unit 209 notified of the event information determines information (display items) to be displayed on the notification screen. In step S321, the notification unit 209 generates notification definition information based on the display items determined in step S320. In step S322, the notification unit 209 displays a popup notification by providing the generated notification definition information to the print support system 211. Details of steps S320 and S321 will now be described with reference to FIG. 4.

FIG. 4 is a flowchart illustrating details of the notification screen display item determination processing (steps S320 and S321) of the notification unit 209. The processing illustrated in the flowchart of FIG. 4 is implemented by the CPU 111 executing the program of the notification unit 209 stored in the external storage device 114.

In step S401, the CPU 111 initially acquires the event information notified from the print support system 211.

In step S402, the CPU 111 determines whether the event type of the acquired event (event information) is “warning”. Events are set as either “error” or “warning” depending on their level of significance. In the present embodiment, “error” is considered to have a higher level of significance than that of “warning”. An example of the specific determination method of step S402 will be described.

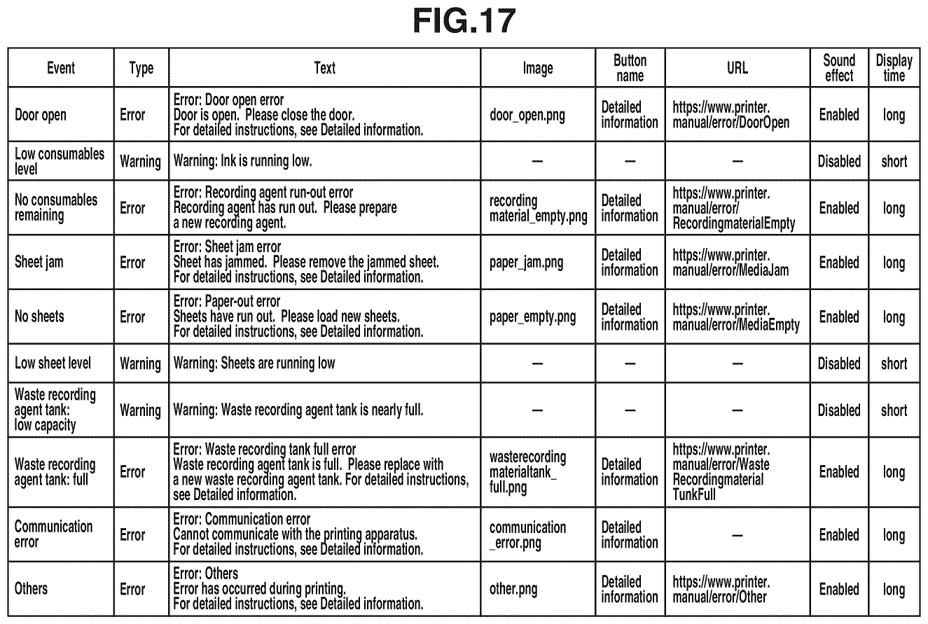

For example, the extension application 204 stores in advance table information that assigns “error” or “warning” to each event as illustrated in FIG. 17. The CPU 111 determines the event type by referring to the event information acquired in step S401 and the “type” column of the table information.

In a case where, in step S402, the event type of the event information is determined to be “error” (event of high significance), the processing proceeds to step S403. In step S403, the CPU 111 generates notification definition information for error display.

In step S404, the CPU 111 sets a message based on an error type in the generated notification definition information. The CPU 111 refers to the “text” column of the table information illustrated in FIG. 17 and determines the message to be displayed on the display unit 119.

In step S405, the CPU 111 sets an image based on the error type. The CPU 111 refers to the table information illustrated in FIG. 17, and sets the image corresponding to the event acquired in step S401 as the image to be displayed on the display unit 119. Examples of the image include ones illustrating the error content.

In step S406, the CPU 111 sets a link button for a web manual page based on the error type. The link is intended to display a webpage describing the solution to the occurring error. The CPU 111 refers to the table information illustrated in FIG. 17, and sets the Uniform Resource Locator (URL) corresponding to the event acquired in step S401 as the URL corresponding to the link button.

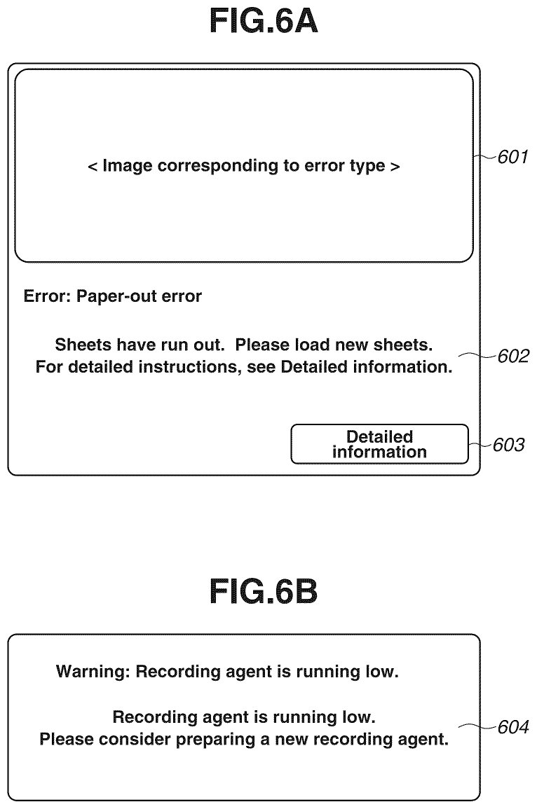

In step S407, the CPU 111 configures sound effect settings upon notification display. Examples of the sound effect settings upon notification display include whether to play sound effects in displaying popup notifications illustrated in FIGS. 6A and 6B on the display unit 119. The CPU 111 refers to the table information of FIG. 17, and sets whether to play a sound effect corresponding to the event acquired in step S401. In the present embodiment, the CPU 111 configures the sound effect settings to play a sound effect when the event type is “error”, and to play no sound effect when the event type is “warning”. This facilitates the user to notice the occurrence of errors, which are events that need to be resolved to continue printing.

In step S408, the CPU 111 sets notification display time information. The notification display time information refers to information about the time from when a popup notification is displayed on the display unit 119 to when the popup notification is hidden. The CPU 111 refers to the “display time” column of the table information illustrated in FIG. 17. In the present embodiment, there are two types of display time settings, “long” and “short”. Both settings are intended to display a popup image for a predetermined time, and “long” provides a longer display time than that of “short”. In the present embodiment, the display time is set to “long” if the event type is “error”, and set to “short” if the event type is “warning”. This facilitates the user to notice the occurrence of errors, which are events that need to be resolved to continue printing.

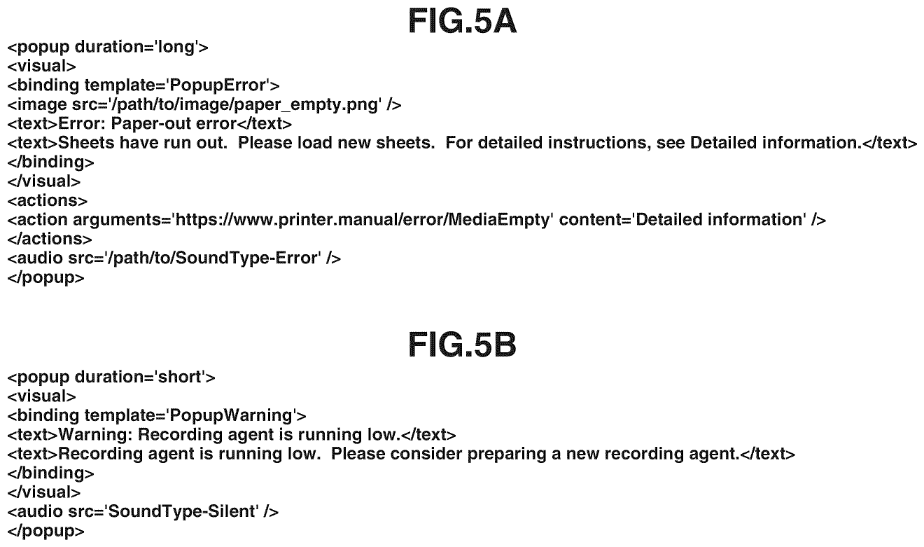

In step S409, the CPU 111 notifies the print support system 211 of display instructions for an error notification screen based on the notification definition information in which various types of information are set. The notification unit 209 notifies the print support system 211 of the information illustrated in FIG. 5A. Based on the content notified from the notification unit 209, the print support system 211 displays the popup screen illustrated in FIG. 6A, for example. The size of the popup screen displayed by the print support system 211 varies with the content displayed within the popup screen.

On the other hand, if, in step S402, the event type of the event information acquired in step S401 is determined to be “warning” (YES in step S402), the processing proceeds to step S410. In step S410, the CPU 111 determines whether the warning event that has occurred is to be notified. An example of the specific determination method in step S410 will now be described. The extension application 204 stores in advance internal table information indicating whether each event handled as a warning is to be notified. The CPU 111 determines whether the warning event that has occurred is to be notified by comparing the warning event with the table information.

If, in step S410, the warning event is determined to be notified (YES in step S410), the processing proceeds to step S411. In step S411, the CPU 111 generates notification definition information for warning display.

In step S412, the CPU 111 sets a message based on the warning type in the generated notification definition information. Specifically, the CPU 111 refers to the table information illustrated in FIG. 17, acquires text corresponding to the event acquired in step S401, and sets the text as the message to be displayed.

In step S413, the CPU 111 notifies the print support system 211 of display instructions for a warning notification screen based on the notification definition information in which various types of information are set.

On the other hand, if, in step S410, the warning event is determined to not be notified (NO in step S410), the processing ends without the CPU 111 performing the processing of steps S411 to S413. Specific examples of the notification definition information generated through the series of processes of steps S403 to S408 and steps S411 to S412 will be described below with reference to FIGS. 5A and 5B. A specific example of the table information that the notification unit 209 refers to in steps S402 to S408 is illustrated in FIG. 17.

FIG. 17 is a diagram for conceptually describing the table information that the notification unit 209 refers to. This table information defines the following items in association with each event: the event type, text to be displayed on the popup notification screen, image, button name, URL to be opened when the button is pressed, presence or absence of sound effects, and notification display time. In step S402, the CPU 111 can determine the level of significance by acquiring the corresponding event type information with the event information notified from the print support system 211 as the key.

Moreover, the CPU 111 sets pieces of information with the event information notified from the print support system 211 as the key. The pieces of information refer to the event type, text to be displayed on the popup notification screen, image, button name, URL to be opened when the button is pressed, presence or absence of sound effects, and notification display time. These pieces of information are set in the notification definition information in steps S403 to S408.

Specifically, the text information is set in step S404. The image information is set in step S405. The URL information and the button name are set in step S406. The sound effect information is set in step S407. The notification display time information is set in step S408.

Events that are not registered in the table of FIG. 17 are processed as ones that do not need to be notified. Items not listed in the table of FIG. 17 are not set or written to the notification definition information. For example, if the notified event is “low consumables level”, a popup screen including text is displayed. This popup screen does not include images indicating the state of the printing apparatus 102 or links to web manuals.

FIG. 5A is a diagram for describing a specific example of the notification definition information generated by the series of processes of steps S403 to S408.

The popup element is the root element for defining a notification screen. The child elements of this popup element define the notification content. The duration attribute included in the popup element specifies the display time of the notification, where “long” represents 5 sec (seconds). The visual element is an element for defining elements to be displayed on the notification screen. The binding element is an element for specifying the type of content to be displayed on the notification. In this example, since the attribute template=‘PopupError’ is specified, notification definition information in the event of errors is used.

This notification definition information is capable of specifying sound effects to be used upon notification display, aside from images, messages, and user-executable actions (buttons). The image element is an element for specifying an image to be displayed on the notification. The src attribute included in the image element is an attribute for specifying the path where the image is stored. The text elements are elements for specifying the text to be displayed on the notification. In this example, two text elements are used to specify a title and a description of the error. The actions element is an element for defining one or more actions that the user can execute on the notification. Child elements of this element define the specific action content. In this example, one action is defined. The action element is an element for defining the action. The arguments attribute specifies the URL to be launched when the action is executed. The content attribute specifies the label of the action. The audio element specifies sound effects to accompany the notification. The src attribute specifies the path of the sound effect file. In the present embodiment, a sound effect named SoundType-Error that represents the occurrence of an error is used in displaying the notification.

FIG. 5B is a diagram for describing a specific example of the notification definition information generated by the series of processes of steps S411 and S412. A detailed description of elements and attributes that are redundant with those of FIG. 5A will be omitted. In this example, the duration attribute included in the popup element specifies short (2 sec). Since the attribute template=‘PopupWarning’ is specified, notification definition information in the event of warnings is used. This notification definition information is capable of specifying messages and sound effects to be used in displaying the notification. In this example, the src attribute of the audio element specifies a sound effect file SoundType-Silent. With this file specified, no sound effect is played (silent) in displaying the notification.

FIGS. 6A and 6B are diagrams illustrating specific examples of the notification screens displayed based on the notification definition information described with reference to FIGS. 5A and 5B.

In FIG. 6A, a section 601 displays the image stored at the path specified by the src attribute of the image element in FIG. 5A. The image provides a specific illustration of how to resolve the error. For example, in the case of a paper-out error, the image illustrates how to load new sheets on the feed tray of the printing apparatus 102.

A section 602 displays the text specified by the text elements of FIG. 5A. A button for opening the URL specified by the arguments attribute of the action element in FIG. 5A is located in a section 603. The label specified by the content attribute of the action element is displayed on the button. When the user presses the button in the section 603, the URL is displayed by the default browser. In the first embodiment, when this button is selected, a web manual page related to errors and warnings is displayed.

The display time of this notification is 5 sec, which is specified by the duration attribute of FIG. 5A. When the notification is displayed, a sound effect indicating the occurrence of an error, specified by the audio element of FIG. 5A, is played. The UI screen of the notification unit 209 is displayed when the area of the notification screen other than the button in the section 603 is pressed. The UI screen displayed by the notification unit 209 displays the remaining level of the recording agent and the name of the job being processed by the printing apparatus 102, in addition to the content displayed on the popup screen.

In FIG. 6B, a section 604 displays the text specified by the text elements of FIG. 5B. The display time of this notification is 2 sec, which is specified by the duration attribute of FIG. 5B. Since the silent sound effect file is specified by the audio element of FIG. 5B, no sound effect is played when this notification is displayed. The UI screen of the notification unit 209 is displayed when the area of this notification screen is pressed.

As described above, according to the present embodiment, the notification unit 209 generates notification definition information based on the level of significance (error or not) of the event information notified from the print support system 211, and displays a notification screen based on the notification definition information. Appropriate information based on the level of significance of the event that has occurred is thereby notified to the user. Specifically, if the event occurring in the printing apparatus 102 is an event of high significance (error), the text indicating the content of the error that has occurred is displayed along with additional information. Examples of the additional information include an error-indicating image and a link button for a web manual page describing the solutions to the error. Control may also be performed to play sound effects in displaying the notification expressing the occurrence of error.

If the event occurring in the printing apparatus 102 is a warning of low significance, a notification that displays only text indicating the warning content is displayed. Moreover, if the significance of the warning to the user is low, no notification is displayed at all. It will be understood that the display time of the notification screen may be set depending on the level of significance of the event that has occurred. Such control facilitates the user to acquire the levels of significance of events occurring during printing and information needed for resolving errors by simply checking the display content of the notifications. Inflexible notification screens may result in the user failing to get information about events that have occurred by overlooking the notification screens upon the occurrence of the events and missing the opportunity to open the UI screen of the notification unit 209.

As in the present embodiment, performing control such as setting sound effects upon display of the notification screen and increasing the display time for significant events can reduce the possibility for the user to overlook the occurrence of highly significant events in particular.

### Second Embodiment

The first embodiment has described a method for setting popup display content depending on the type of event notified from the OS. Events notified from the OS include ones for which the notification content can be changed depending on the type and configuration information of the connected printing apparatus. For example, for inkjet machines that are often used at home, users can be prompted to purchase recording agents by displaying a warning when the recording agents are running low. On the other hand, for electrophotographic machines that are often used in the office, recording agent purchases may be handled by a person in charge, and warnings to individual users may not be needed. The second embodiment is characterized in that the popup display content is configured using information about the type, hardware configuration, capability information, and the like of the connected printing apparatus, in addition to events notified from the OS.

The basic hardware configuration and software configuration are similar to the example described in the first embodiment. A description thereof will thus be omitted.

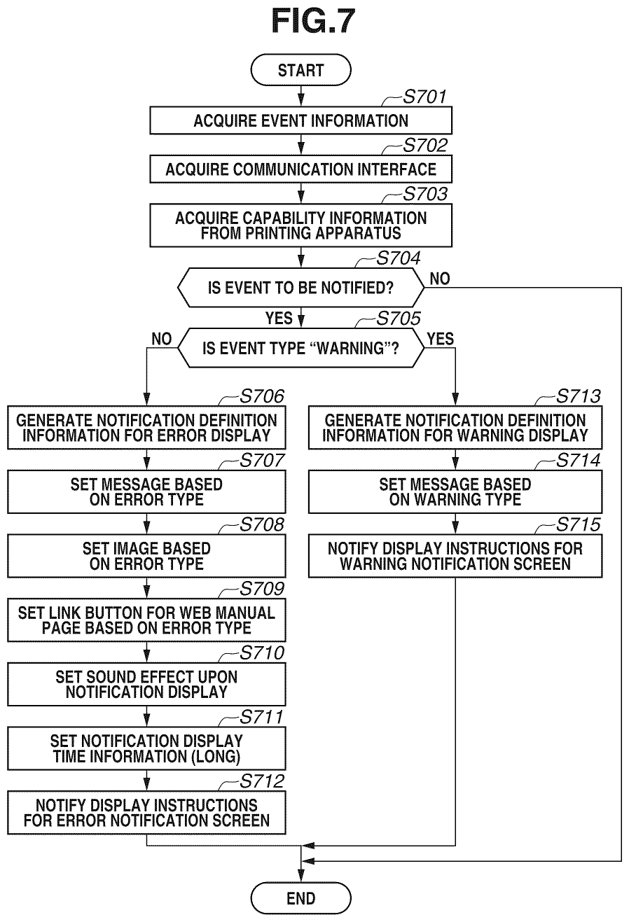

FIG. 7 is a flowchart illustrating details of the processing of steps S320 and S321 performed by the notification unit 209 according to the present embodiment. The processing illustrated in FIG. 7 is implemented by the CPU 111 executing the program corresponding to the notification unit 209.

In step S701, the CPU 111 initially acquires event information notified from the print support system 211.

In step S702, the CPU 111 acquires a communication interface provided by the OS. The communication interface is associated with the printing apparatus 102, and provides the notification unit 209 with a function of transmitting and receiving given information using a communication protocol supported by the printing apparatus 102 (for example, IPP).

In step S703, the CPU 111 acquires capability information from the printing apparatus 102 using the communication interface acquired in step S702. Examples of the capability information to be acquired include image forming method information (for example, inkjet or electrophotography), device configuration information (for example, the presence or absence of a finisher), and device type information (for example, physical device or virtual device configured in the cloud) about the printing apparatus 102.

In step S704, the CPU 111 determines whether the event acquired in step S701 is one to be notified, based on the capability information acquired in step S703.

An example of the determination method is to determine whether the event that has occurred immediately stops the print processing of the printing apparatus 102 (error) or can possibly stop the print processing (warning) based on the information about the image forming method, device configuration, or model type. For example, if the event that has occurred is “DoorOpen”, which indicates that the door to access consumables mounted in the printing apparatus 102 is open, inkjet printing apparatuses stop print processing while the door is open. On the other hand, some electrophotographic imaging apparatuses can continue print processing. If the event notified from the OS is “DoorOpen”, the CPU 111 then determines whether the image forming method of the connected printing apparatus 102 is inkjet or electrophotography. If the connected printing apparatus 102 is an inkjet printing apparatus, the CPU 111 determines yes in step S704. On the other hand, if the connected printing apparatus is an electrophotographic printing apparatus, the CPU 111 determines no in step S704.

In some cases, the connected printing apparatus can be a virtual device configured in the cloud. When an error or warning occurs in the actual printing apparatus connected to the virtual device, the status of the virtual device can also become “error” or “warning”. However, even with the status of the virtual device being “error” or “warning”, print data can be transmitted to the cloud and submitted to the print queue on the virtual device. If a virtual device is selected as the connected printing apparatus, the CPU 111 therefore determines no in step S704 regardless of the type of the notified event.

As described above, the extension application 204 according to the second embodiment switches whether to issue notifications depending on the image forming method and device configuration of the printing apparatus 102 and whether the printing apparatus 102 is an actual printing apparatus or a virtual device in the cloud.

If, in step S704, the event is determined to be notified (YES in step S704), the processing proceeds to step S705. The notification unit 209 then performs the processing of steps S705 to S712 or steps S705 and S713 to S715 in order. The processing of steps S705 to S712 is similar to that of steps S402 to S409, and the processing of steps S713 to S715 is similar to that of steps S411 to S413. A description thereof will thus be omitted. On the other hand, if, in step S704, the event is determined to not be notified (NO in step S704), the processing ends without the notification unit 209 issuing notifications.

As described above, according to the present embodiment, the notification unit 209 determines whether the event is to be notified based on the event information notified from the print support system 211 and the capability information about the printing apparatus 102, and notifies the user of appropriate information depending on the event type. Specifically, since whether printing can be continued differs even for the same event depending on the device configuration and apparatus type, notifications are displayed only for events that can interfere with the continuation of printing. This enables the user to recognize only significant events in light of the capability information of the model, even with the same events.

In the second embodiment, whether to issue notifications for events acquired in step S701 is changed based on the information about the connected printing apparatus 102. Even for the same events acquired in step S701, the notification content may be changed depending on the capability information and configuration information about the connected printing apparatus 102. Suppose, for example, a no-consumables error is acquired in step S701. If the image forming method of the connected printing apparatus 102 is inkjet, the notification unit 209 generates notification definition information for displaying “Error: No-ink error. Ink has run out. Please prepare new ink”. On the other hand, if the image forming method of the connected printing apparatus 102 is electrophotography, the notification unit 209 generates notification definition information for displaying “Error: No-toner error. Toner has run out. Please prepare a new toner cartridge”. In such a manner, messages suitable for the connected printing apparatus can be displayed.

### Third Embodiment

The present embodiment describes a configuration where display items are determined based on the event type and error type of an event occurring in a printing apparatus 102 in the notification screen display item determination processing of a notification unit 209. In the first embodiment, the object for displaying the web manual for resolving the error that has occurred is displayed on the popup notification regardless of the type of the event that has occurred. In the third embodiment, when a predetermined type of error occurs, a link object to a webpage different from the web manual page is displayed.

The basic hardware configuration and software configuration are similar to the example described in the first embodiment. A description thereof will thus be omitted.

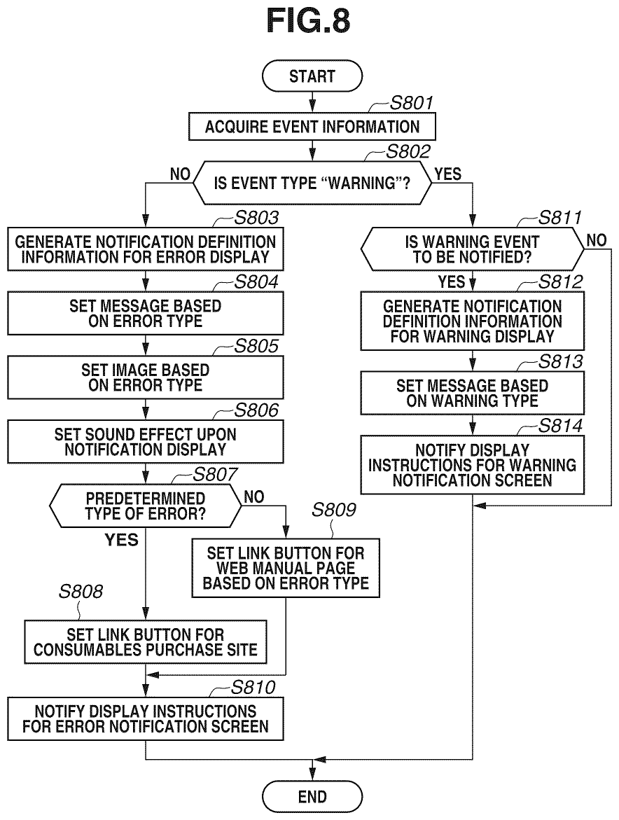

FIG. 8 is a flowchart illustrating details of the notification screen display item determination processing (steps S320 and S321) of the notification unit 209 according to the present embodiment. The flowchart illustrated in FIG. 8 is implemented by the CPU 111 reading the program of the notification unit 209 and executing the program.

In step S801, the CPU 111 initially acquires event information notified from the print support system 211. In step S802, the CPU 111 determines the level of significance of the acquired event information. If, in step S802, the event information is determined to be “error” (event of high significance) (NO in step S802), the processing proceeds to step S803. In step S803, the CPU 111 generates notification definition information for error display.

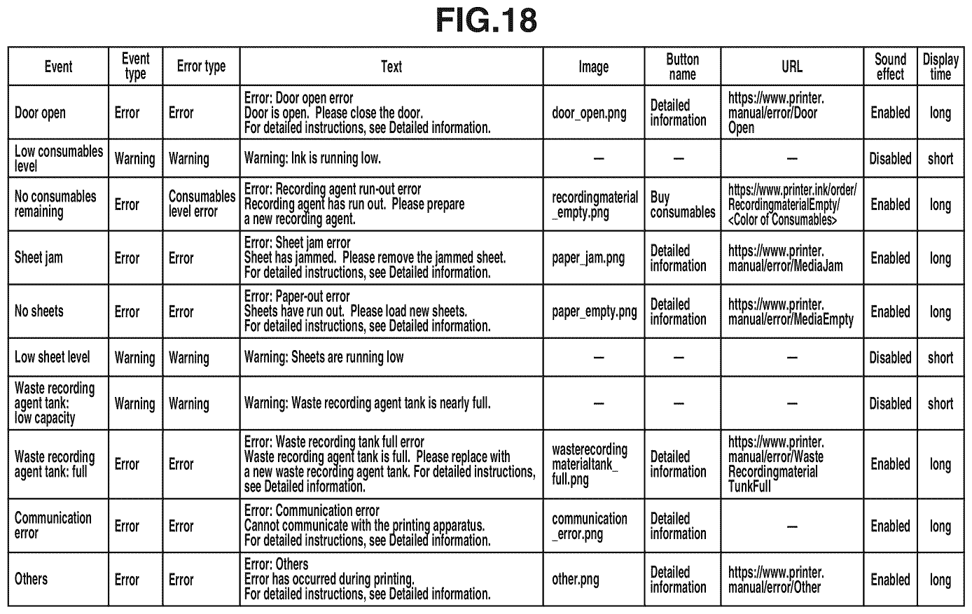

In step S804, the CPU 111 sets a message based on the error type in the generated notification definition information. In step S804, the CPU 111 refers to a table illustrated in FIG. 18, stored in the extension application 204. The CPU 111 sets the information at the “text” column and the row corresponding to the acquired event as the message.

In step S805, the CPU 111 sets an image based on the error type. The CPU 111 refers to the table illustrated in FIG. 18. The CPU 111 sets the image indicated by the “image” column at the row corresponding to the event acquired in step S801 as the image to be displayed.

In step S806, the CPU 111 sets sound effects upon notification display. The CPU 111 refers to the table illustrated in FIG. 18, and sets whether to play a sound effect in response to the event acquired in step S801.

In step S807, the CPU 111 determines whether the error type of the event notified in step S801 is a predetermined type. In step S807, the CPU 111 refers to the “error type” column of the table illustrated in FIG. 18. In the present embodiment, recording agent level-related errors are assumed to be a predetermined type of errors. An example of the recording agent level-related errors is an event that is notified from the printing apparatus 102 to the information processing apparatus when the remaining level of the recording agent such as ink and toner falls below a predetermined value.

If, in step S807, the event that has occurred is determined to be a recording agent level-related error (YES in step S807), the processing proceeds to step S808. In step S808, the CPU 111 sets a link button for a consumables purchase site in the generated notification definition information. The CPU 111 refers to the “URL” column of FIG. 18 and acquires the URL to use. The CPU 111 may set different URLs depending on the color of the consumables running low.

On the other hand, if, in step S807, the event that has occurred is determined to not be a recording agent level-related error (NO in step S807), the processing proceeds to step S809. In step S809, the CPU 111 sets a link button for a web manual page corresponding to the error type in the generated notification definition information.

In step S810, the CPU 111 displays a notification screen based on the notification definition information in which various types of information are set. FIG. 18 illustrates a specific example of the table information that the CPU 111 refers to in steps S802 to S809. On the other hand, the processing of steps S811 to S814 for the case where the event information is determined to be “warning” (event of low significance) in step S802 is similar to the processing of steps S410 to S413. A description thereof will thus be omitted.

In step S807 of FIG. 8, whether the error that has occurred is a recording agent level-related error is determined by referring to the “error type” column of FIG. 18. Alternatively, the processing may proceed to step S808 if the event acquired by the CPU 111 in step S801 is a predetermined event in step S807. In such a case, if, in step S807, the event acquired in step S801 is not a predetermined event, the processing proceeds to step S809.

FIG. 18 is a diagram for conceptually describing the table information that the notification unit 209 refers to. This table information defines the following items in association with each event: the event type, error type, text to be displayed on the popup notification screen, image, button name, URL to be opened when the button is pressed, presence or absence of sound effects, and notification display time.

In step S802, the notification unit 209 can determine the level of significance by acquiring the corresponding event type information with the event information notified from the print support system 211 as the key. Moreover, the notification unit 209 sets pieces of information with the event information notified from the print support system 211 as the key. The pieces of information include the event type, text to be displayed on the popup notification screen, image, button name, URL to be opened when the button is pressed, presence or absence of sound effects, and notification display time. Such pieces of information are set in the notification definition information in steps S804 to S809.

Specifically, the text information is set in step S804. The image information is set in step S805. The notification display time information is set in step S806. In step S807, the notification unit 209 can determine the error type by acquiring the corresponding error type information with the event information notified from the print support system 211 as the key. If the notified event indicates a recording agent level-related error, URL information and a button name specific to the recording agent level-related error are set in step S808. If the notified event indicates other than the recording agent level-related error, URL information and a button name corresponding to the error type are set in step S809.

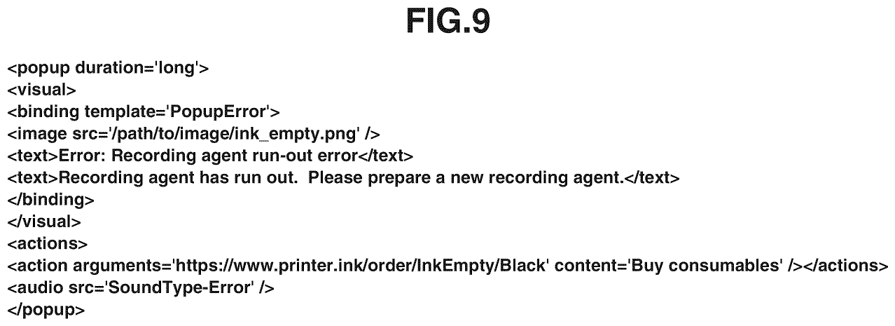

FIG. 9 is a diagram for describing a specific example of the notification definition information generated by the notification unit 209 through the series of processes of steps S803 to S808. Since the elements and attributes in the notification definition information are similar to those illustrated in FIGS. 5A and 5B, detailed descriptions thereof will be omitted. In this example, the duration attribute included in the popup element specifies long (5 sec). Since the attribute template=‘PopupError’ is specified, notification definition information in the event of errors is used. In this example, the arguments attribute of the action element sets the URL for opening the recording agent purchase page. Recording agent information about the recording agent that has run out is attached to the URL. When the URL is opened, the purchase page for the depleted recording agent is displayed by the default browser.

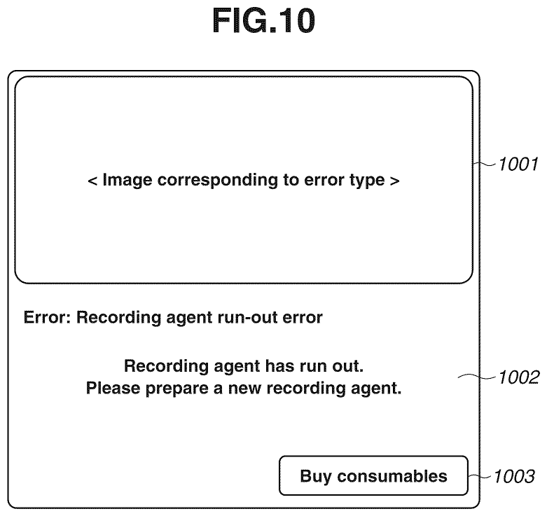

FIG. 10 is a diagram illustrating a specific example of the notification screen displayed based on the notification definition information described with reference to FIG. 9. A section 1001 displays the image stored at the path specified by the src attribute of the image element in FIG. 9. A section 1002 displays the text specified by the text elements of FIG. 9. A button for opening the URL specified by the arguments attribute of the action element in FIG. 9 is located in a section 1003. The label specified by the content attribute of the action element is displayed on the button. When the user presses the button in the section 1003, the recording agent purchase page is displayed by the default browser. The display time of this notification is 5 sec, which is specified by the duration attribute of FIG. 9. When the notification is displayed, the sound effect indicating the occurrence of an error, specified by the audio element of FIG. 9, is played.

As described above, according to the present embodiment, the notification unit 209 generates notification definition information based on the level of significance and the event type of the event information notified from the print support system 211, and displays a notification screen based on the notification definition information. Appropriate information based on the level of significance and the event type of the event that has occurred is thereby notified to the user. Specifically, if the event occurring in the printing apparatus 102 is an event of high significance (error) and applies to the recording agent level-related error, an action (button) capable of opening the recording agent purchase page from the notification screen is displayed. Information tailored to specific event types can thereby be presented to the user on the notification screen.

### Fourth Embodiment

The present embodiment describes a configuration where if the type of event occurring in a printing apparatus 102 indicates a specific value in the notification screen display item determination processing of a notification unit 209, the notification unit 209 acquires additional information related to notification display from the printing apparatus 102. The basic hardware configuration and software configuration are similar to the example described in the first embodiment, and a description thereof will thus be omitted.

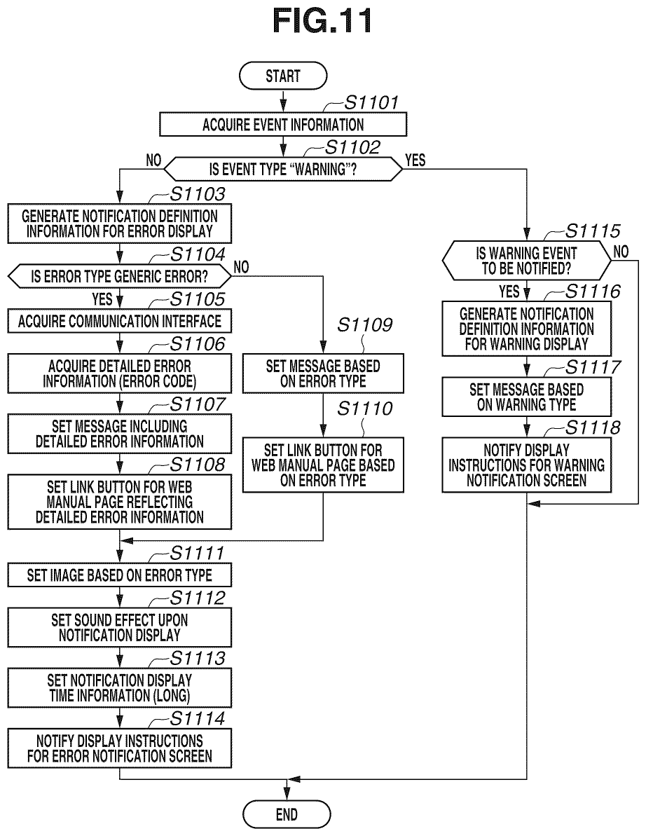

FIG. 11 is a flowchart illustrating details of the notification screen display item determination processing (steps S320 and S321) of the notification unit 209 according to the present embodiment. The processing illustrated in FIG. 11 is implemented by the CPU 111 executing the program of the notification unit 209.

In step S1101, the CPU 111 acquires event information notified from the print support system 211.

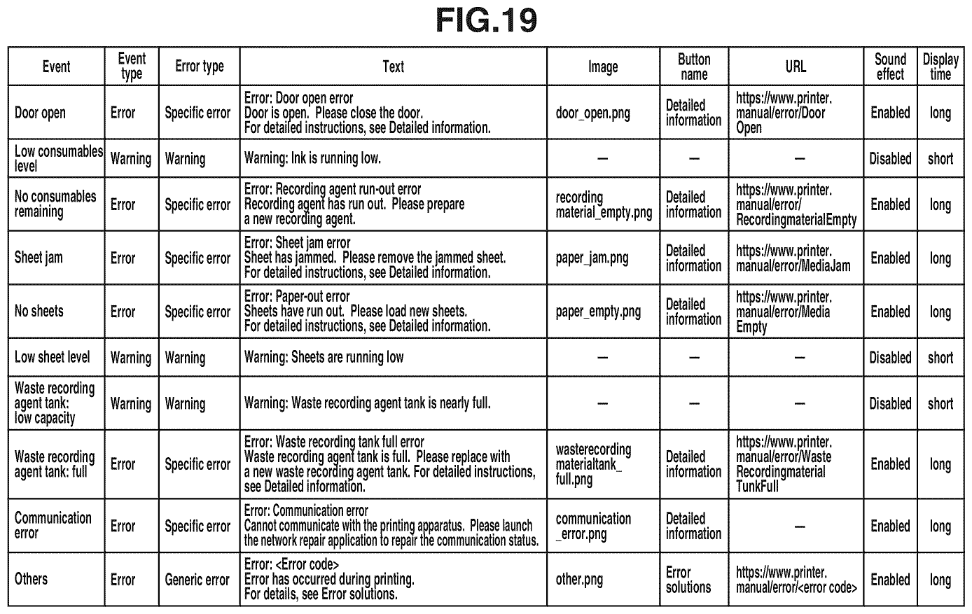

In step S1102, the CPU 111 determines whether the event type of the acquired event information is “warning”. FIG. 19 illustrates table information stored in the extension application 204 according to the present embodiment. The CPU 111 refers to the “event type” column of the table information illustrated in FIG. 19. Suppose that the event type “error” indicates events of higher significance than that of “warning”.

If, in step S1102, the event type of the event information is determined to be “error” (NO in step S1102), the processing proceeds to step S1103. In step S1103, the CPU 111 generates notification definition information for error display.

In step S1104, the CPU 111 determines whether the error type of the event acquired in step S1101 is a generic error. The CPU 111 refers to the “error type” column of the table illustrated in FIG. 19, and determines whether the error that has occurred is a generic error. Generic errors refer to errors that are not included in the error types defined within the print support system 211 (such as a no-ink error and a paper-out error).

If, in step S1104, the event that has occurred is determined to represent a generic error (YES in step S1104), the processing proceeds to step S1105. In step S1105, the CPU 111 acquires a communication interface provided by the OS.

The communication interface is associated with the printing apparatus 102, and provides the notification unit 209 with a function of transmitting and receiving given information using a communication protocol (for example, IPP) supported by the printing apparatus 102.

In step S1106, the CPU 111 acquires detailed error information from the printing apparatus 102 using the acquired communication interface. Examples of the detailed error information to be acquired include identifiers (error codes) for identifying respective errors.

In step S1107, the CPU 111 sets a message including the detailed error information (error code) in the notification definition information. The CPU 111 acquires text corresponding to the generic error from the table information illustrated in FIG. 19. The CPU 111 sets the text to be displayed based on the acquired text information and the error code acquired from the printing apparatus 102.

In step S1108, the CPU 111 sets a link button for a web manual page reflecting the detailed error information in the generated notification definition information.

On the other hand, if, in step S1104, the event that has occurred is determined to not be a generic error (NO in step S1104), the processing proceeds to step S1109. An example of the case where the error that has occurred is not a generic error is where the error that has occurred is a specific error.

In step S1109, the CPU 111 sets a message based on the error type in the notification definition information. The CPU 111 refers to the “text” column of the table information illustrated in FIG. 19, and sets the message to be displayed.

In step S1110, the CPU 111 sets a link button for the web manual page based on the error type. The CPU 111 refers to the “button name” and “URL” columns of FIG. 19, and sets the button information.

After step S1108 or S1110, i.e., in step S1111, the CPU 111 sets an image based on the error type in the notification definition information.

In step S1112, the CPU 111 sets the sound effect upon notification display.

In step S1113, the CPU 111 sets the notification display time.

In step S1114, the CPU 111 notifies the print support system 211 of the notification definition information in which various types of information are set.

FIG. 19 illustrates a specific example of the table information that the notification unit 209 refers to in steps S1102 to S1113. Meanwhile, the processing of steps S1115 to S1118 for situations where the event type of the event information is determined to be “warning” (event of low significance) in step S1102 is similar to that of steps S410 to S413. A description thereof will thus be omitted.

FIG. 19 is a diagram illustrating an example of the table information that the notification unit 209 refers to. This table information defines the following items in association with each event: the event type, error type, text to be displayed on the popup notification screen, image, button name, URL to be opened when the button is pressed, presence or absence of sound effects, and notification display time.

In step S1102, the CPU 111 can determine the level of significance by acquiring the corresponding event type information with the event information notified from the print support system 211 as the key. In step S1104, the CPU 111 can determine the error type by acquiring the corresponding error type information with the event information notified from the print support system 211 as the key. The CPU 111 also acquires pieces of information with the event information notified from the print support system 211 as the key. The pieces of information include the event type, text to be displayed on the popup notification screen, image, button name, URL to be opened when the button is pressed, presence or absence of sound effects, and notification display time. The pieces of information are set in the notification definition information in steps S1106 to S1110. If the notified event indicates “generic error”, the text information, URL information, and button name associated with the error type “generic error” are set in steps S1106, S1107, and S1108, respectively. On the other hand, if the error type of the notified event matches “specific error”, the text information, URL information, and button name corresponding to the error type are set in steps S1109 and S1110. Moreover, the image information, sound effect information, and display time information corresponding to each error are set in steps S1111, S1112, and S1113, respectively.

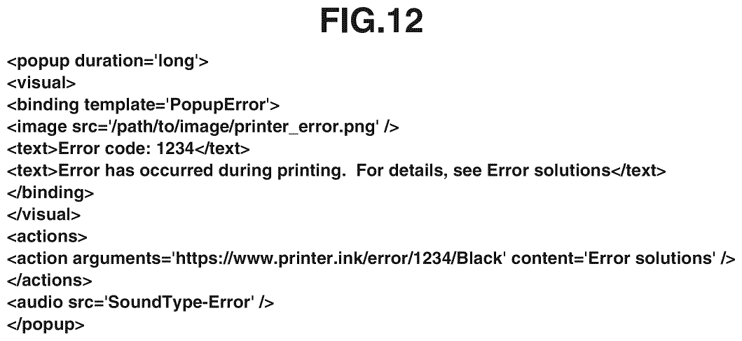

FIG. 12 is a diagram for describing a specific example of the notification definition information generated by the notification unit 209 through the series of processes of steps S1103 to S1108 and S1111 to S1114. The elements and attributes in the notification definition information are similar to those illustrated in FIGS. 5A and 5B, and detailed descriptions thereof will thus be omitted.

In this example, the duration attribute included in the toast element specifies long (5 sec). Since the attribute template=‘PopupError’ is specified, notification definition information in the event of errors is used. The text element sets a message reflecting the detailed error information (error code) set in step S1107. The URL set in the arguments attribute of the action element of this example includes a value reflecting the error code set in step S1108. Since the error code identifying the error is reflected on the URL, the page describing the corresponding error solutions is displayed by the default browser opening the URL.

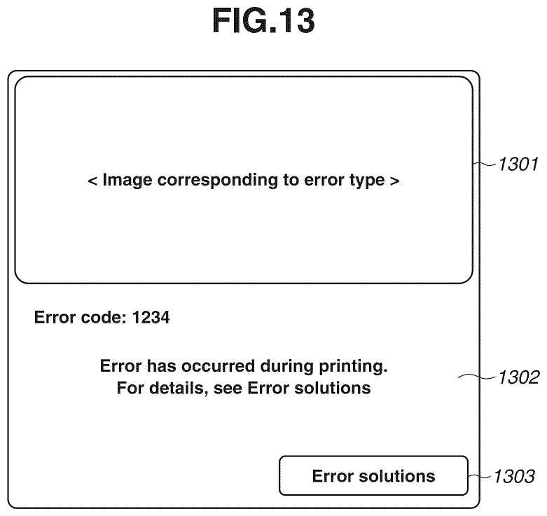

FIG. 13 is a diagram illustrating a specific example of the notification screen displayed based on the notification definition information described with reference to FIG. 12. In FIG. 13, a section 1301 the image stored at the path specified by the src attribute of the image element in FIG. 12. A section 1302 displays the text specified by the text elements of FIG. 12. A button for opening the URL specified by the arguments attribute of the action element in FIG. 12 is located in a section 1303. The label specified by the content attribute of the action element is displayed on the button. When the user presses the button in the section 1303, the page describing the solutions to the error that has occurred is displayed by the default browser. The display time of the notification is 5 sec, which is specified by the duration attribute of FIG. 12. Moreover, when the notification is displayed, the sound effect indicating the occurrence of an error, specified by the audio element of FIG. 12, is played.

As described above, according to the present embodiment, the notification unit 209 generates notification definition information based on the level of significance and the event type of the event information notified from the print support system 211. Here, if the event type has a value indicating a generic error, the notification unit 209 further acquires detailed error information from the printing apparatus 102. The notification unit 209 reflects the acquired detailed error information on the notification definition information, and displays a notification screen based on the notification definition information. The print support system 211 defines several event types in advance, and inputs event type information matching the event occurring in the printing apparatus 102 to the notification unit 209. If the event occurring in the printing apparatus 102 is one specific to the printing apparatus vendor, event type information indicating a generic error may be input to the notification unit 209 since the event type is unknown to the print support system 211. In the case where the event type notified from the print support system 211 indicates a generic error, the error that has occurred is unidentifiable from that information alone, and it is therefore difficult to provide the user with appropriate guidance for error solutions. The notification unit 209 thus acquires a value (error code) uniquely identifying the error from the printing apparatus 102 as detailed error information, whereby a web manual link reflecting the error code can be set in the notification definition information. This enables the user to open the webpage describing the solutions to the error that has occurred from the notification screen even when the error content is not identifiable based only on the information notified from the print support system 211.

### Fifth Embodiment

The present embodiment describes a configuration where an application that can provide more detailed guidance about a specific error is launched if the type of event occurring in a printing apparatus 102 indicates the specific error in the notification screen display item determination processing of a notification unit 209. Since the basic hardware configuration and software configuration are similar to the example described in the first embodiment, a description thereof will be omitted.

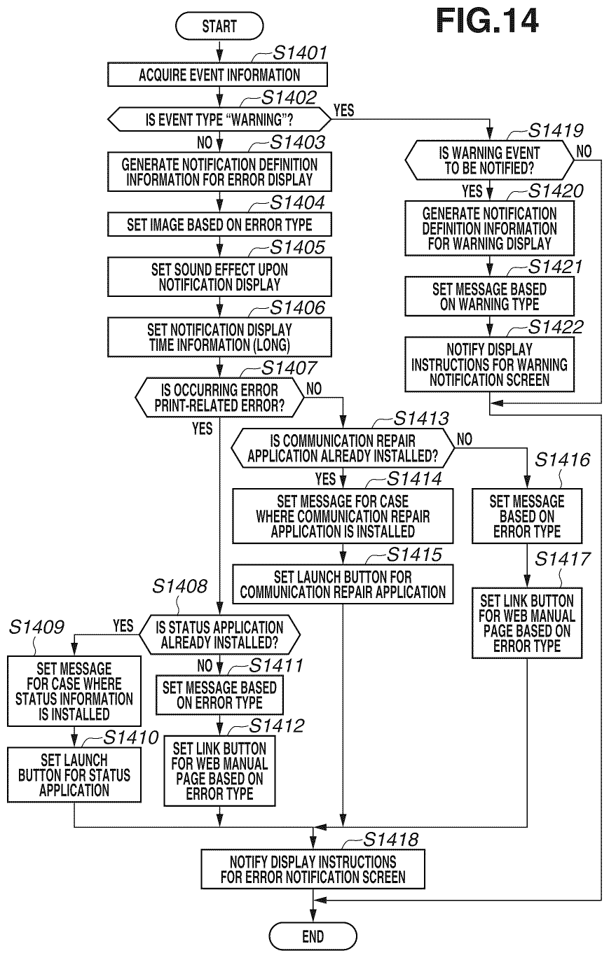

FIG. 14 is a flowchart illustrating details of the notification screen display item determination processing (S320 and S321) of the notification unit 209 according to the present embodiment. The flowchart illustrated in FIG. 14 is implemented by the CPU 111 executing the program of the notification unit 209.

In step S1401, the CPU 111 acquires event information notified from the print support system 211.

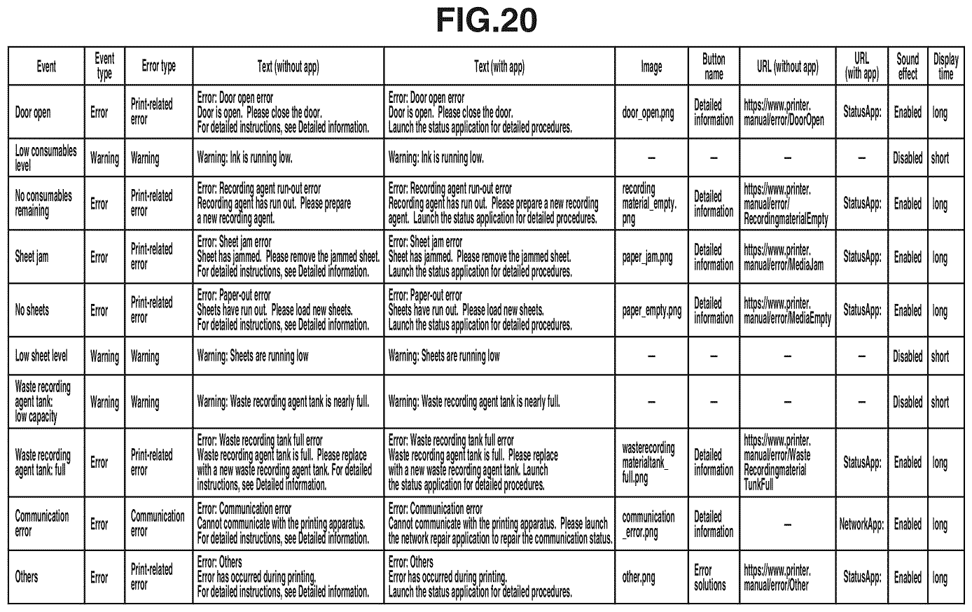

In step S1402, the CPU 111 determines whether the event type of the acquired event information is “warning”. FIG. 20 illustrates table information stored by the extension application 204. The CPU 111 refers to the event type in this table information and makes the determination.

If, in step S1402, the event type of the event information is determined to be “warning” (NO in step S1402), the processing proceeds to step S1403. In step S1403, the CPU 111 generates notification definition information for error display.

In step S1404, the CPU 111 sets an image based on the error type. In step S1405, the CPU 111 sets a sound effect upon notification display. In step S1406, the CPU 111 sets a notification display time.

In step S1407, the CPU 111 determines whether the error type of the error that has occurred is “print-related error”. The CPU 111 refers to the “error type” column of the table information illustrated in FIG. 20. In the present embodiment, “print-related error” and “communication error” are illustrated as error types. Print-related errors are errors related to the print processing performed by the printing apparatus 102. Examples include no-recording-agent errors such as a no-ink error and a no-toner error, as well as a paper jam error and a paper-out error. Communication errors refer to errors related to communication between the host computer 101 and the printing apparatus 102.

If, in step S1407, the event that have occurred is determined to be a print-related error associated with the print processing (YES in step S1407), the processing proceeds to step S1408. In step S1408, the CPU 111 determines whether a status application capable of providing a detailed description of the print-related error that has occurred is installed on the host computer 101.

The status application is an application provided by the vendor that provides the printing apparatus 102. The status application is installed on the host computer 101 by the user downloading the status application from the printer vendor's website or an application distribution page provided by the OS vendor. Alternatively, the status application may be installed on the host computer 101 using a storage medium bundled with the printing apparatus 102.

The status application has a function of providing more detailed descriptions of print-related errors occurring in the printing apparatus 102 than does the extension application 204.

If, in step S1408, the status application is determined to be already installed (YES in step S1408), the processing proceeds to step S1409. In step S1409, the CPU 111 sets a message for the case where the status application is installed in the event type-specific notification definition information. In step S1410, the CPU 111 sets a launch button for the status application in the notification definition information.

On the other hand, if, in step S1408, the status application is determined to not be installed (NO in step S1408), the processing proceeds to step S1411. In step S1411, the CPU 111 sets a message based on the event type.

In step S1412, the CPU 111 sets a link button for the web manual page based on the event type.

If, in step S1407, the event that has occurred is determined to be a communication error indicating that communication with the printing apparatus 102 becomes no longer possible during print processing (NO in step S1407), the processing proceeds to step S1413. In step S1413, the CPU 111 determines whether a communication repair application having a function of restoring the communication state is installed on the host computer 101.

The communication repair application is an application provided by the vendor that provides the printing apparatus 102. The communication repair application has the function of, when the communication between the printing apparatus 102 and the host computer 101 is no longer possible, restoring the state where communication can be properly performed. If, in step S1413, the communication repair application is determined to be already installed (YES in step S1413), the processing proceeds to step S1414. In step S1414, the CPU 111 sets a message for the case where the communication repair application is installed in the notification definition information. In step S1415, the CPU 111 sets a launch button for the communication repair application. On the other hand, if, in step S1413, the communication repair application is determined to not be installed (NO in step S1413), the processing proceeds to step S1416. In step S1416, the CPU 111 sets a message based on the event type. In step S1417, the CPU 111 sets a link button for the web manual page based on the error type. After the processing of any one of steps S1410, S1412, S1415, and S1417, i.e., in step S1418, the CPU 111 notifies the print support system 211 of the notification definition information in which various types of information are set. FIG. 20 illustrates a specific example of the table information that the notification unit 209 refers to in steps S1402 to S1417. On the other hand, the processing of steps S1419 to S1422 for the case where the event type of the event information is determined to be “warning” (event of low significance) in step S1402 is similar to that of steps S410 to S413. A description thereof will thus be omitted.

FIG. 20 is a diagram for conceptually describing the table information that the notification unit 209 refers to. This table information defines the following items in association with each event: the event type, error type, text to be displayed on the popup notification screen, image, button name, URL to be opened when the button is pressed, presence or absence of sound effects, and notification display time. In step S1402, the notification unit 209 can determine the level of significance by acquiring the corresponding event type information with the event information notified from the print support system 211 as the key. In step S1408, the notification unit 209 can determine the error type by acquiring the corresponding error type information with the event information notified from the print support system 211 as the key. In steps S1404 to S1406, the image information, sound effect information, and display time information associated with each event are set.

If the error type of the notified event indicates “print-related error” and the status application is determined to be already installed, the CPU 111 refers to the “text (with app)” and “URL (with app)” columns of FIG. 20. In step S1409, the CPU 111 sets the information of the “text (with app)” column of FIG. 20 in the notification definition information. In step S1410, the CPU 111 sets the information of the “URL (with app) ”column of FIG. 20 in the notification definition information.

On the other hand, if the error type of the notified error indicates “print-related error” and the status application is determined to not be installed, the CPU 111 refers to the “text (without app)” and “URL (without app)” columns of FIG. 20. In step S1411, the CPU 111 refers to the “text (without app)” column of FIG. 20, and sets the text to be displayed in the notification definition information. In step S1412, the CPU 111 refers to the “URL (without app)” column of FIG. 20, and sets the URL in the notification definition information.

If the error type of the notified event indicates “communication error” and the communication repair application is determined to be already installed, the CPU 111 performs the following processing. In step S1414, the CPU 111 refers to the “text (with app)” column of the event associated with the communication error, and sets the text in the notification definition information. In step S1415, the CPU 111 refers to the “URL (with app)” column of the event, and sets the URL in the notification definition information.

On the other hand, if the error type of the notified event indicates “communication error” and the communication repair application is determined to not be installed, the CPU 111 performs the following processing. In step S1416, the CPU 111 refers to the “text (without app)” column of the event associated with the communication error, and sets the text in the notification definition information. In step S1417, the CPU 111 refers to the “URL (without app)” column of the event, and sets the URL in the notification definition information.

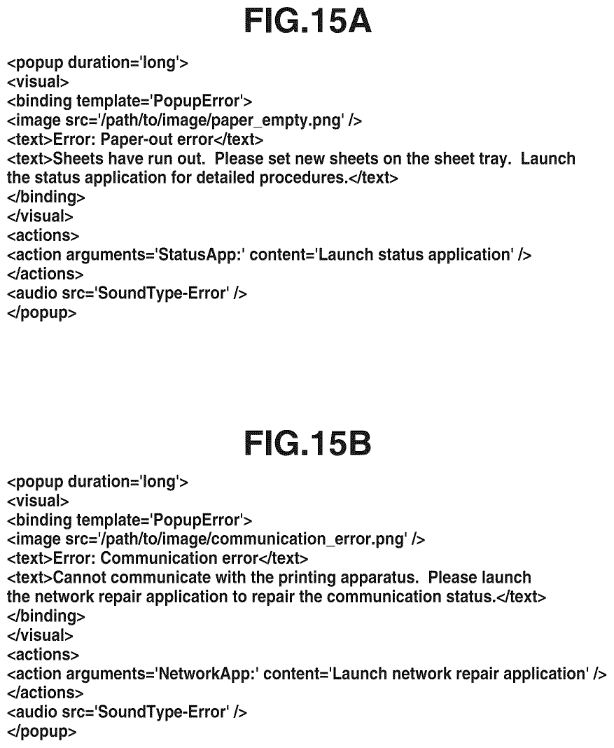

FIGS. 15A and 15B are diagrams for describing specific examples of the notification definition information generated by the notification unit 209 through the series of processes of steps S1403 to S1414. The elements and attributes in the notification definition information are similar to those illustrated in FIGS. 5A and 5B, and detailed descriptions thereof will thus be omitted. FIG. 15A illustrates the notification definition information for the case where the launch button for the status application is set in step S1410. In this example, the duration attribute included in the popup element specifies long (5 sec). Since the attribute template=‘PopupError’ is specified, notification definition information in the event of errors is used. In this example, a Uniform Resource Identifier (URI) for launching the status application is set in the arguments attribute of the action element. This URI is a character string registered with the host computer 101 in installing the status application. If a URI is specified in the arguments attribute, the OS can launch the application associated with the URI. FIG. 15B illustrates the notification definition information for the case where the launch button for the communication repair application is set in step S1413. In this example, the duration attribute included in the popup element specifies long (5 sec). Since the attribute template=‘PopupError’ is specified, notification definition information in the event of errors is used. In this example, a URI for launching the communication repair application is set in the arguments attribute of the action element.

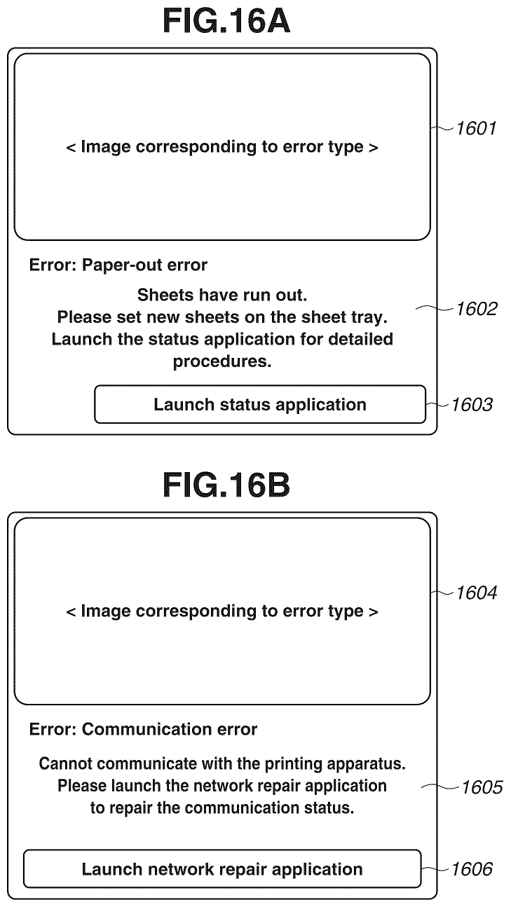

FIGS. 16A and 16B are diagrams illustrating specific examples of the notification screens displayed based on the notification definition information described with reference to FIGS. 15A and 15B, respectively. In FIG. 16A, a section 1601 displays the image stored at the path specified by the src attribute of the image element in FIG. 15A. A section 1602 displays the text specified by the text elements of FIG. 15A. A button for launching the status application specified by the arguments attribute of the action element in FIG. 15A is located in a section 1603. The label specified by the content attribute of the action element is displayed on the button. When the user presses the button in the section 1603, the status application is launched. The display time of this notification is 5 sec, which is specified by the duration attribute of FIG. 15A. Moreover, when the notification is displayed, the sound effect indicating the occurrence of an error, specified by the audio element of FIG. 15A, is played. In FIG. 16B, a section 1604 displays the image stored at the path specified by the src attribute of the image element in FIG. 15B. A section 1605 displays the text specified by the text elements of FIG. 15B. A button for launching the communication repair application specified by the arguments attribute of the action element in FIG. 15B is located in a section 1606. The label specified by the content attribute of the action element is displayed on the button. When the user presses the button in the section 1606, the communication repair application is launched. The display time of this notification is 5 sec, which is specified by the duration attribute of FIG. 15B. Moreover, when the notification is displayed, the sound effect indicating the occurrence of an error, specified by the audio element of FIG. 15B, is played.

As described above, according to the present embodiment, the notification unit 209 generates notification definition information based on the level of significance and the event type of the event information notified from the print support system 211, and displays a notification screen based on the notification definition information.

If the event type has a value indicating a print-related error, whether the status application capable of providing a detailed description of print-related errors is installed is determined. If the status application is installed, information for launching the status application is set in the notification definition information. On the other hand, if the event type has a value indicating a communication error, whether the communication repair application capable of repairing the communication state is installed is determined. If the communication repair application is installed, information for launching the communication repair application is set in the notification definition information. This can provide more detailed information about the event occurring in the printing apparatus 102, and if there is an application capable of resolving the issue that has occurred, the user can directly launch the application from the notification screen. In the present embodiment, the status application or the communication repair application is described to be launched from the notification screen of FIG. 16A or 16B. In other configurations, the status application or the communication repair application may be directly launched based on the event type without the intermediary of the notification screen.

The present disclosure is not limited to the foregoing embodiments, and various changes and modifications can be made without departing from the spirit and scope of the present disclosure. The following claims are therefore appended to make public the scope of the present disclosure.

According to an embodiment of the present disclosure, printing apparatus vendors can customize the content of notifications based on events occurring during printing when printing is performed using a standard driver.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A non-transitory computer-readable storage medium storing an application program which cause an information processing apparatus to perform a control method, the application program cooperating with an operating system of the information processing apparatus, the control method comprising:
acquiring predetermined information;
performing, in a case where the predetermined information indicates that a recording agent in a printer has run out, a process to cause a display of the information processing apparatus to display a link button for purchase site of the recording agent;
and performing, in a case where the predetermined information indicates that the recording agent in the printer is low, a process to cause the display to display a message indicating that the recording agent is low, without displaying the link button.

2. The non-transitory computer-readable storage medium according to claim 1, wherein the predetermined information comprises event information received from the printer via an Internet Printing Protocol compliant generic print function, the event information indicating a level of significance that includes an error and a warning, and wherein display is performed via a generic notification function of an operating system.

3. The non-transitory computer-readable storage medium according to claim 1, wherein, in the case where the predetermined information indicates that the recording agent has run out, the link button is configured to open a recording agent purchase webpage, the URL including information identifying the depleted recording agent.

4. The non-transitory computer-readable storage medium according to claim 1, wherein, in the case where the predetermined information indicates that the recording agent is low, the application program causes the display to present only a message indicating that the recording agent is low, without any link button, without any device-state image, and with no sound effect.

5. The non-transitory computer-readable storage medium according to claim 1, wherein the application program sets a notification display time and sound effect based on the level of significance of the predetermined information, including playing a sound effect and using a longer display time for errors, and using no sound effect and a shorter display time for warnings.

6. The non-transitory computer-readable storage medium according to claim 1, wherein the application program determines whether to issue any notification based on capability information of the connected printer, including at least an image forming method and whether the printer is a virtual device, and refrains from issuing notifications when a virtual device is selected.

7. The non-transitory computer-readable storage medium according to claim 1, wherein, when the predetermined information indicates a generic error, the application program acquires detailed error information from the printer via a communication interface and reflects the detailed error information in both a message to be displayed and a URL to a web manual page.

8. The non-transitory computer-readable storage medium according to claim 1, wherein the application program generates notification definition information by referring to table information that correlates events with message text, images, button labels, URLs, presence or absence of sound effects, and notification display time.

9. The non-transitory computer-readable storage medium according to claim 1, wherein, for error events other than recording agent level-related errors, the application program causes the display to present a link button that opens a web manual page describing solutions to the error.

10. The non-transitory computer-readable storage medium according to claim 1, wherein, when the predetermined information indicates a print-related error and a status application is installed on the information processing apparatus, the application program causes the display to present a button that launches the status application.

11. A control method of an information processing apparatus, the control method being executed by executing an application program cooperating with an operating system of the information processing apparatus, the control method comprising:
acquiring predetermined information;
performing, in a case where the predetermined information indicates that a recording agent in a printer has run out, a process to cause a display of the information processing apparatus to display a link button for purchase site of the recording agent; and
performing, in a case where the predetermined information indicates that the recording agent in the printer is low, a process to cause the display to display a message indicating that the recording agent is low, without displaying the link button.

12. An information processing apparatus comprising at least one processor operating a process, the process being executed by executing an application program cooperating with an operating system of the information processing apparatus, the process comprising:
acquiring predetermined information;
performing, in a case where the predetermined information indicates that a recording agent in a printer has run out, a process to cause a display of the information processing apparatus to display a link button for purchase site of the recording agent; and
performing, in a case where the predetermined information indicates that the recording agent in the printer is low, a process to cause the display to display a message indicating that the recording agent is low, without displaying the link button.
